(19) United States
(12) Patent Application Publication
(10) Pub. No.: US 2012/0226439 A1
(43) Pub. Date: Sep. 6, 2012

(54) NAVIGATION DEVICE AND NAVIGATION MODE SWITCH METHOD

(75) Inventor: YAO-CHEN CHAN, Tu-Cheng (TW)

(73) Assignee: HON HAI PRECISION INDUSTRY CO., LTD., Tu-Cheng (TW)

(21) Appl. No.: 13/169,042

(22) Filed: Jun. 27, 2011

(30) Foreign Application Priority Data
Mar. 4, 2011 (TW) 100107240

(51) Int. Cl. G01C 21/00

(52) U.S. Cl. 701/450; 701/457

(57) ABSTRACT

A navigation device includes a display, a positioning system to receive geographical information, a storage unit for storing the received geographical information and a plurality of applications, and a processor. The processor acquires parameter of the navigation device, and switches the navigation device between a two-dimensional navigation mode and a three-dimensional navigation mode based on a comparison result between the acquired parameters and a preset parameter in the navigation device. A related navigation mode switch method is also provided.

### BACKGROUND

1. Technical Field

The present disclosure relates to navigation devices and, particularly, to a navigation device capable of switching between a two-dimensional navigation mode and a three-dimensional navigation mode and a navigation mode switch method.

2. Description of Related Art

Some navigation devices, for example, Global Position System (GPS) navigation devices, can display geographical information for navigation in a two-dimensional navigation mode or in a three-dimensional navigation mode. However, these navigation devices cannot automatically switch navigation modes between the two-dimensional navigation mode and the three-dimensional navigation mode. This lack of an automatic function needs to be addressed.

### BRIEF DESCRIPTION OF THE DRAWINGS

The components of the drawings are not necessarily drawn to scale, the emphasis instead being placed upon clearly illustrating the principles of a navigation device and a navigation mode switch method. Moreover, in the drawings, like reference numerals designate corresponding parts throughout several views.

FIG. 1 is a block diagram of a navigation device capable of switching between a two-dimensional navigation mode and a three-dimensional navigation mode, in accordance with an exemplary embodiment.

FIG. 2 is a schematic view showing the navigation device of FIG. 1 arranged in a vehicle.

FIG. 3 is a flowchart of a navigation mode switch method in accordance with an exemplary embodiment.

### DETAILED DESCRIPTION

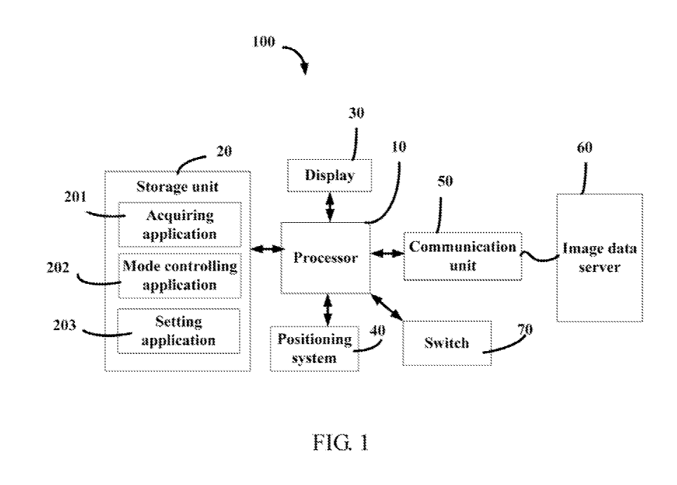

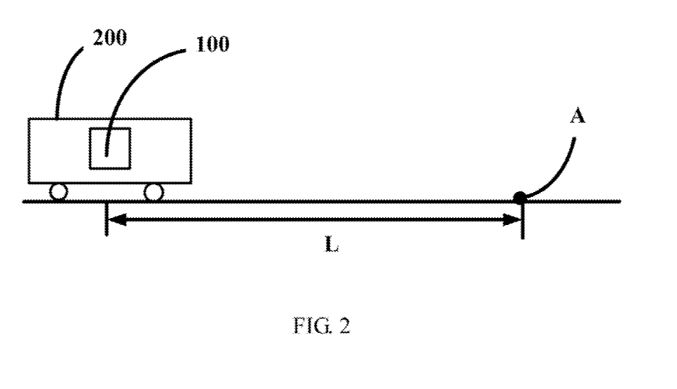

Referring to FIGS. 1-2, a navigation device 100 capable of selectively displaying geographical information for navigation in a two-dimensional (2D) navigation mode or a three-dimensional (3D) navigation mode is provided. The device 100 includes a processor 10, a storage unit 20, a display 30, and a positioning system 40, for instance, a GPS unit. The processor 10 executes various software components in the storage unit 20 to perform various functions of the navigation device 100. The positioning system 40 receives geographical information. The processor 30 stores the received geographical information in the storage unit 20. The processor 30 processes the received geographical information to display a navigation map on the display 30 in the 2D navigation mode or in the 3D navigation mode. The navigation device 100 may be installed in a vehicle 200 or a handheld device, such as a car, or a smart phone. In the 2D navigation mode, the navigation map is displayed in a 2D mode. In the 3D navigation mode, the navigation map is displayed in a 3D mode. In this embodiment, the navigation device 100 provides an image navigation mode in the 3D navigation mode. In the image navigation mode, geographical information for navigation is displayed on the display 30 as the real environment. The navigation device 100 further includes a communication unit 50 communicating with an image data server 60 to acquire the geographical information for image navigation from the image data server 60.

The storage unit 20 further stores an acquiring application 201 and a mode controlling application 202. The acquiring application 201 includes various software components which may be implemented by the processor 10 to acquire a parameter for switching between the 2D navigation mode and the 3D navigation mode. The acquiring application 201 may be implemented to acquire the parameter continuously or at a preset time interval. The parameter may be a velocity of the device 100, or a distance L between the device 100 and a preset destination A. The preset destination A may be a place where a user of the device 100 wants to go. The mode controlling application 202 includes various software components which may be implemented by the processor 10 to switch the navigation device 100 between the 2D navigation mode and the 3D navigation mode based on a comparison result between the acquired parameter and a preset parameter in the navigation device 100. The preset parameter may be a preset velocity or a preset distance

In a first embodiment, the acquiring application 201 may be a detection application which may be implemented by the processor 10 to detect the velocity of the device 100. The acquiring application 201 may be implemented by the processor 10 to detect the velocity in real time or at a preset time interval. The mode controlling application 202 is implemented by the processor 10 to control the navigation device 100 to operate in the 2D navigation mode if the detected velocity is equal to or greater than the preset velocity, and control the navigation device 100 to operate in the 3D navigation mode if the detected velocity is less than the preset velocity. For example, assuming the preset velocity is 30 KM/H, the mode controlling application 202 controls the device 100 to operate in the 2D navigation mode if the detected velocity is equal to or greater than 30 KM/H, and controls the device 100 to operate in the 3D navigation mode if the detected velocity is less than 30 KM/H. When the device 100 moves at a lower speed, the vehicle 200 including the device 100 may be at a corner of a street, a undefined place, or near the destination A, the 3D navigation mode may be needed to provide a better navigation.

In a second embodiment, the acquiring application 201 may be a calculation application which may be implemented by the processor 10 to calculate the distance L between the device 100 and the preset destination A according to the geographical information. The acquiring application 201 may be implemented by the processor 10 to calculate the distance L in real time or at a preset time interval. The mode controlling application 202 is implemented by the processor 10 to control the navigation device 100 to operate in the 2D navigation mode if the calculated distance L is equal to or greater than the preset distance, and control the navigation device 100 to operate in the 3D navigation mode if the calculated distance L is less than the preset distance.

The storage unit 20 further includes a setting application 203. The setting application 203 includes various software components, which may be implemented by the processor 10 to set the preset velocity, or the destination A and the preset distance in response to input from the user.

In this embodiment, the navigation device 100 further includes a switch 70 to manually switch the navigation modes of the device 100 between the two-dimensional navigation mode and the three-dimensional navigation mode.

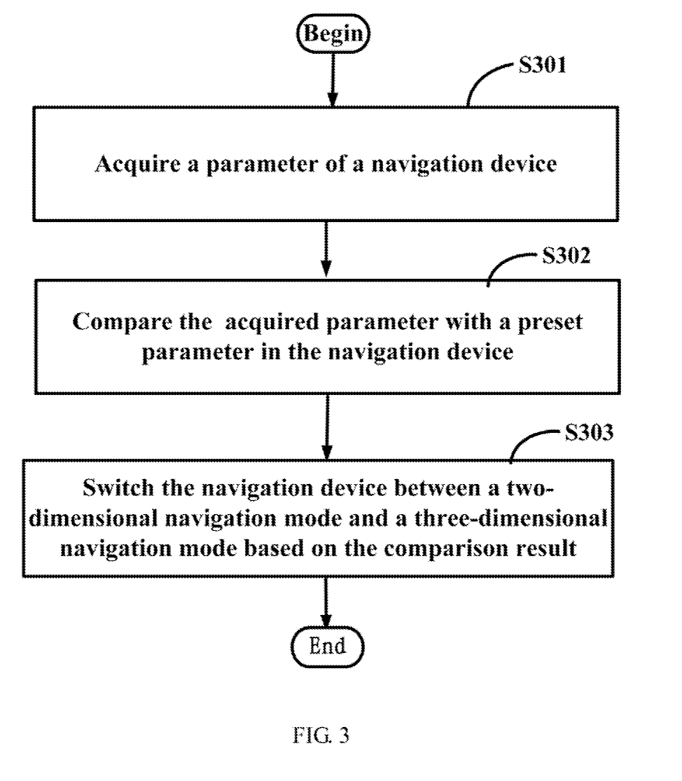

Referring to FIG. 3, a flowchart of a navigation mode switch method implemented by the navigation device 100 of FIG. 1 in accordance with an exemplary embodiment is illustrated.

In step S301, the acquiring application 201 is implemented by the processor 10 to acquire the parameter of the navigation device 100 (e.g., the velocity of the navigation device 100 or the distance L between the navigation device 100 and the preset destination A) for switching between the 2D navigation mode and the 3D navigation mode.

In step S302, the mode controlling application 202 is implemented by the processor 10 to compare the acquired parameter with a preset parameter in the navigation device 100. For example, in the first embodiment, the mode controlling application 202 is controlled by the processor 10 to compare the acquired velocity with the preset velocity; and in the second embodiment, the mode controlling application 202 is implemented by the processor 10 to compare the acquired distance with the preset distance.

In step S303, the mode controlling application 202 is further implemented by the processor 10 to switch the navigation device 100 between the 2D navigation mode and the 3D navigation mode based on the comparison result. For example, in the first embodiment, if the acquired velocity is equal to or greater than the preset velocity, the mode controlling application 202 is implemented by the processor 10 to control the navigation device 100 to operate in the 2D navigation mode, otherwise, controls the navigation device 100 to operate in the 3D navigation mod. In the second embodiment, if the acquired distance is equal to or greater than the preset distance, the mode controlling application 202 is implemented by the processor 10 to control the navigation device 100 to operate in the 2D navigation mode, otherwise, controls the navigation device 100 to operate in the 3D navigation mode.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A navigation device comprising:
a display;
a positioning system to receive geographical information;
a storage unit to store the received geographical information and a plurality of applications; and
a processor to execute the plurality of applications,
wherein the plurality of applications comprise instructions executable by the processor to
acquire a parameter of the navigation device; and
switch the navigation device between a two-dimensional navigation mode and a three-dimensional navigation mode based on a comparison result between the acquired parameter and a preset parameter in the navigation device.

2. The navigation device as described in claim 1, wherein the plurality of applications further comprise instructions executable by the processor to acquire the parameter continuously or at a preset time interval.

3. The navigation device as described in claim 1, wherein the three-dimensional navigation mode comprises an image navigation mode, and the navigation device further comprises a communication unit communicating with an image data server to acquire the geographical information used in the image navigation mode from the image data server.

4. The navigation device as described in claim 1, wherein the preset parameter is a preset velocity, and the acquired parameter is a velocity of the navigation device, the plurality of applications comprises instructions executable by the processor to detect the velocity of the navigation device, control the navigation device to operate in the two-dimensional navigation mode if the detected velocity is equal to or greater than the preset velocity, and control the navigation device to operate in the three-dimensional navigation mode if the detected velocity is less than the preset velocity.

5. The navigation device as described in claim 1, wherein the preset parameter is a preset distance, and the acquired parameter is a distance between the navigation device and a preset destination, the plurality of applications comprises instructions executable by the processor to calculate the distance according to the geographical information, control the navigation device to operate in the two-dimensional navigation mode if the calculated distance is equal to or greater than the preset distance, and control the navigation device to operate in the three-dimensional navigation mode if the calculated distance is less than the preset distance.

6. The navigation device as described in claim 1, wherein the plurality of applications further comprises instructions executable by the processor to set the preset parameter in response to input from a user.

7. The navigation device as described in claim 1, further comprising a switch to generate switch signals for switching the navigation mode of the navigation device between the two-dimensional navigation mode and the three-dimensional navigation mode.

8. A navigation mode switch method used in a navigation device, the navigation device comprising a positioning system and a storage unit, the positioning system being configured to receive geographical information, the storage unit storing the received geographical information, the navigation mode switch method comprising:
acquiring a parameter of the navigation device;
comparing the acquired parameter with a preset parameter in the navigation device; and
switching the navigation device between a two-dimensional navigation mode and a three-dimensional navigation mode based on the comparison result.

9. The switch method as described in claim 8, wherein the preset parameter is a preset velocity, the acquiring step is detecting a velocity of the navigation device, the comparing step is comparing the detected velocity with the preset velocity, and the switching step is controlling the navigation device to operate in the two-dimensional navigation mode if the detected velocity is equal to or greater than the preset velocity, and controlling the navigation device to operate in the three-dimensional navigation mode if the detected velocity is less than the preset velocity.

10. The switch method as described in claim 8, wherein the preset parameter is a preset distance, the acquiring step is calculating a distance between the navigation device and a preset destination according to the geographical information, the comparing step is comparing the calculated distance with the preset distance, and the switching step is controlling the navigation device to operate in the two-dimensional navigation mode if the calculated distance is equal to or greater than the preset distance, and control the navigation device to operate in the three-dimensional navigation mode if the calculated distance is less than the preset distance.
